(19) United States
(12) Patent Application Publication
(10) Pub. No.: US 2014/0279670 A1
(43) Pub. Date: Sep. 18, 2014

(54) Consistent Interface for Target Group Business Object

(71) Applicants: Dirk Wagner, Schiffwiler (DE); Wolfgang Gentes, Zweibruecken (DE); Joerg Steinmann, Voelklingen (DE)

(72) Inventors: Dirk Wagner, Schiffwiler (DE); Wolfgang Gentes, Zweibruecken (DE); Joerg Steinmann, Voelklingen (DE)

(73) Assignee: SAP AG, Walldorf (DE)

(21) Appl. No.: 13/832,344

(22) Filed: Mar. 15, 2013

(51) Int. Cl. G06Q 10/10

(52) U.S. Cl. CPC G06Q 10/107
USPC 705/342

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a target group business object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about target groups. The medium comprises program code for receiving, via a message-based interface exposing at least one service as defined in a service registry and from a heterogeneous application executing in an environment of computer systems providing message-based services, a first message for requesting maintenance of one or more target groups, including a list of business partners that include customers, prospects and/or contact persons, categorized according to specific criteria, including geographical locations and/or common interests. The first message includes a message package hierarchically organized as a target group bundle maintain request sync message entity and a target group package including at least one target group entity. Each target group entity includes at least one of an object node sender technical identifier (ID) and a change state ID. The medium further comprises program code for sending a second message to the heterogeneous application responsive to the first message.

Implementations can include the following. Each target group entity further includes at least one of the following: a note entity and a member entity. Each target group entity further includes at least one of the following: a universally unique identifier (UUID), an ID, a description, and a life cycle status code. The note entity includes at least one of the following: an object node sender technical ID and content text. The member entity includes at least one of the following: an object node sender technical ID, a UUID, a customer UUID, a customer internal ID, a contact person UUID, and a contact person internal ID.

In another aspect, a distributed system operates in a landscape of computer systems providing message-based services defined in a service registry. The system comprises a graphical user interface comprising computer readable instructions, embedded on tangible media, for requesting maintenance of one or more target groups, including a list of business partners that include customers, prospects and/or contact persons, categorized according to specific criteria, including geographical locations and/or common interests, the instructions using a request. The system further comprises a first memory storing a user interface controller for processing the request and involving a message including a message package hierarchically organized as a target group bundle maintain request sync message entity and a target group package including at least one target group entity. Each target group entity includes at least one of an object node sender technical identifier (ID) and a change state ID. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example Target Group object model.

FIG. 33 depicts an example Target Group Bundle Maintain Request Sync message data type.

FIGS. 34-1 through 34-8 collectively depict an example Target Group Bundle Maintain Request Sync element structure.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

### (1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

### (2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

### (3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

### (4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

### (5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

### (6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

Packages also may be used to represent hierarchy levels. For example, as depicted in FIG. 10, the Item Package 1000 includes Item 1002 with subitem xxx 1004, subitem yyy 1006, and subitem zzz 1008.

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

### (1) Cardinality of Relationships

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

### (2) Types of Relationships

### (a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

### (b) Aggregation

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

### (c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

### (3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

### e) Structural Patterns

### (1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

### (2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | Delivery- | |
| DeliveryPriority | | Terms | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase | |
| ParentItemID | | Order | |
| HierarchyType | | Item | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

FIG. 32 illustrates an example object model for a target group business object 32000. Specifically, the object model depicts interactions among various components of the target group business object 32000, as well as external components that interact with the target group business object 32000 (shown here as 32002 through 32006 and 32024 through 32028). The target group business object 32000 includes elements 32008 through 32022, which can be hierarchical, as depicted, and use cardinality relationships, as described above. For example, the target group 32008 hierarchically includes entities member 32010 and overview 32014, among others. Some or all of the entities 32008 through 32022 can correspond to packages and/or entities in the message data types described below.

A Target Group business object can include a list of business partners such as customers, prospects, or contact persons, categorized according to specific criteria such as geographical locations or common interests. The list can be used in campaigns, for example, to promote products or services. A target group can include information that applies to an entire target group and information about members of the target group. The Target Group business object can be associated with the process component Campaign Management, and with the deployment unit Customer Relationship Management. The Target Group business object can be categorized as a Business Administration Object and/or as a Standard Business Object.

A Target Group business object can include various service interfaces, and can be involved in the following process component interactions: External Campaign Management_Campaign Management_Manage Target Group, and External Campaign Management_Campaign Management_Query Target Group.

A ManageTargetGroupIn service interface can replicate target groups from a source system or file to a target system. The ManageTargetGroupIn service interface can be part of the External Campaign Management_Campaign Management_Manage Target Group process component interaction. The ManageTargetGroupIn service interface can include a CheckMaintainBundle operation for checking whether one or more Target Groups can be maintained using imported structured data. The operation can be based on message type Target Group Request Bundle Check Maintain Query_sync (derived from business object Target Group), and/or can be based on message type Target Group Request Bundle Check Maintain Response_sync (derived from business object Target Group). The ManageTargetGroupIn service interface can include a MaintainBundle operation for creating, updating or deleting one or more target groups using imported structured data. The operation can be based on message type Target Group Bundle Maintain Confirmation_sync (derived from business object Target Group), and/or can be based on message type Target Group Bundle Maintain Request_sync (derived from business object Target Group).

A QueryTargetGroupIn service interface can be an interface to query target group data, and can be part of an External Campaign Management_Campaign Management_Query Target Group process component interaction. The QueryTargetGroupIn service interface can include a FindByElements operation for querying target group data by elements. The operation can be based on message type Target Group By Elements Query_sync (derived from business object Target Group), and/or can be based on message type Target Group By Elements Response_sync (derived from business object Target Group).

A Target Group can be group of customers, prospects or contact persons (called members) to be contacted through marketing activities. The Target Group can include a description, a number of members, and services that perform set operations (add, intersect, subtract) on the members. A member of a Target Group can be a customer (organisation or person), a prospect (organisation or person), or a contact person of a customer or prospect. In general, members of a Target Group can have common properties, for instance they can be “all A-Customers in California”. Common properties are generally the basis on which the members of a Target Group are chosen. Similar marketing activities can be executed for members of a Target Group. In some implementations, inactive Target Groups may not be used in marketing activities, as they may be incomplete or under reconstruction.

The elements located directly at the node Target Group can be defined by the inline structure: APCRM_S_TARGET_GROUP_EL. These elements can include UUID, ID, SystemAdministrativeData, Description, MemberNumberValue, and Status. UUID is a universally unique identifier of a Target Group, can be defined by a UUID data type, and can be an alternative key. ID is a human readable unique Identifier of a Target Group, can be defined by a TargetGroupID data type, and can be an alternative key. SystemAdministrativeData is a system administrative date (date and time, identity of creation and change of a Target Group), and can be defined by a SystemAdministrativeData data type. Description is a natural language description of a Target Group, and can be defined by a MEDIUM_Description data type. MemberNumberValue is a number of Members which currently belong to a Target Group, and can be defined by a NumberValue data type qualified by Member. Status is a status of a Target Group, and can include a Status/LifeCycleStatusCode which identifies the life cycle status of a Target Group. In general, marketing activities may not be performed for Target Groups with ActivationStatusCode of “Blocked” or “Obsolete”. An ActivationStatusCode of “Active” can be the default status for new Target Groups. An ActivationStatusCode of “Obsolete” can be a condition for deleting a Target Group.

The following composition relationships to subordinate nodes can exist: Member, with a cardinality of 1:CN, and Overview, with a cardinality of 1:1 (composition can be disabled). The following composition relationships to dependent objects can exist: Attachment Folder, with a cardinality of 1:C, and Text Collection, with cardinality of 1:C. Attachment Folder can include a collection of documents that are attached to a Target Group, and can include administrative data and attached documents that are themselves independent documents. Text Collection can include a collection of texts in natural language with reference to a Target Group.

The following inbound association relationships can exist: CreationIdentity, with a cardinality of 1:CN, and LastChangeIdentity, with a cardinality of 1:CN. CreationIdentity can be an identity that has created a Target Group, and can reference the business object Identity/node Identity. LastChangeIdentity can be an identity that has last changed a Target Group, and can reference the business object Identity/node Identity.

The following specialization associations for navigation to the node Member can exist: AddressableTargetGroupMemberByCommunicationMediumTypeCode, with a target cardinality of CN (filtered), and NonAddressableTargetGroupMemberByCommunicationMediumTypeCode, with a target cardinality of CN (filtered).

AddressableTargetGroupMemberByCommunicationMediumTypeCode can be a type of AddressableTargetGroupMemberByCommunicationMediumTypeCodeFilterElements, with a filter cardinality of C. In some implementations, if CommunicationMediumTypeCode is not specified in a Filter, the ContactAllowedCode of a Customer associated with a Member may be evaluated for the result of the association. The filter elements can be defined by the data type AddressableTargetGroupMemberByCommunicationMediumTypeCodeFilterElements, and may include the optional elements CommunicationMediumTypeCode (with a data type of CommunicationMediumTypeCode), IgnoreBlockedIndicator (with a data type of Indicator), and MemberAddressDeterminationMethodCode (with a data type of TargetGroupMemberAddressDeterminationMethodCode).

NonAddressableTargetGroupMemberByCommunicationMediumTypeCode can specify Members which cannot be addressed through a specific Communication Medium. In general, “NonAddressable” means that the Members cannot be contacted (that is, the attribute ContactAllowedCode in the Common node of the Customer or Prospect does not have the value “Allowed”) or that suitable address information for the specified Communication Medium may not be available. The filter elements can be defined by the data type AddressableTargetGroupMemberByCommunicationMediumTypeCodeFilterElements, and may include the optional elements CommunicationMediumTypeCode (with a data type of CommunicationMediumTypeCode), IgnoreBlockedIndicator (with a data type of Indicator), and MemberAddressDeterminationMethodCode (with a data type of TargetGroupMemberAddressDeterminationMethodCode).

Various integrity conditions can exist for a Target Group business object. A Target Group can have a unique ID. In general, once a Target Group has been saved, the ID may no longer be changed. New Target Groups can receive an ActivationStatusCode of “Inactive”. In some implementations, no marketing activities may be executed for a Target Group with an ActivationStatusCode of “Inactive”.

The following enterprise service infrastructure actions can exist for a Target Group business object: Add Member, Add Members with Reference, Block, Check Addressability with Communication Medium, Create with Reference, Flag as Obsolete, Intersect Members with Reference, Remove All Members, Revoke Obsolescence, Subtract Members with Reference, and Unblock.

The Add Member enterprise service infrastructure action can add a new member to a target group. In general, the Add Member action can add one customer or a customer with a related contact person as a new member to a target group. The Add Member action can optionally include the following parameters, which can be action elements defined by the data type TargetGroupAddMemberActionElements: CustomerInternalID, CustomerUUID, ContactPersonInternalID, and ContactPersonUUID. CustomerInternalID is an identifier of a customer who is to be added to a target group as a member, and can be defined by a BusinessPartnerInternalID data type. When a CustomerID is specified, the CustomerUUID can be empty. CustomerUUID is a universally unique identifier of a customer who can be added to a target group as a member, and can be defined by a UUID data type. When a CustomerUUID is specified, the CustomerID can be empty. ContactPersonInternalID is an identifier of a contact person who can be added to a target group as a member, and can be defined by a BusinessPartnerInternalID data type. When a ContactPersonID is specified, the ContactPersonUUID can be empty. In some implementations, a ContactPersonID may be specified, if a CustomerID or a CustomerUUID is specified. The ContactPersonID can belong to a contact person which is related to the specified customer by an “is contact person of” relationship. ContactPersonUUID is a universally unique identifier of a contact person who can be added to a target group as a member, and can be defined by a UUID data type. When a ContactPersonUUID is specified, the ContactPersonID can be empty. In some implementations, a ContactPersonUUID may be specified, if a CustomerID or a CustomerUUID is specified. The ContactPersonUUID can belong to a contact person which is related to the specified customer by a “is contact person of” relationship. In some implementations, the Add Member action may be called from a user interface (UI) or from another business object.

The Add Members with Reference enterprise service infrastructure action can add referenced objects as Members to a current Target Group. In general, the references can be to root nodes of business object (BO) Activity, root nodes of BO Registered Product (BO Installation Point), root nodes of BO Business Partner, root nodes of BO Business Partner Relationship, outbound nodes of BO Campaign, inbound business transaction document reference nodes of BO Campaign, root nodes of a BO Customer, relationship nodes of a BO Customer, root nodes of BO Customer Contract, root nodes of BO Customer Quote, root nodes of BO Customer Return, root nodes of BO Lead, root nodes of BO Opportunity, root nodes of BO Sales Order, root nodes of BO Service Order, root nodes of BO Service Request, root nodes of another BO Target Group, or member nodes of another BO Target Group. The referenced objects can be resolved into lists of Members (customers/prospects or contact persons), which can then be added to a current Target Group. In some implementations, the Add Members with Reference action may be regarded as a “merge” functionality, as the members of a Target Group can be unique (i.e., no member can be in a Target Group twice). Thus, a Customer/Prospect or Contact Person which already belongs to a Target Group may not be added a second time. For example, a Target Group can include a set of members {A,B,C}, with references to a set of members {B,C,D}. After performing an “add” action, for example, the Target Group can include a set of members {A,B,C,D}. As a precondition, for example, the Life Cycle Status of a Target Group cannot be “obsolete”. Upon changing a Target Group object, for example, a list of Target Group Members can be modified and the attribute “MemberNumberValue” can be updated accordingly. In some implementations, the Add Members with Reference action may be called from a user interface (UI) or from another business object.

The Block enterprise service infrastructure action can block a Target Group from usage in the creation of Marketing Activities (Status Action). For example, the Target Group Life Cycle Status can set to “Blocked”. In general, a blocked Target Group may not be specified for the creation of marketing activities (e.g. by the Mass Data Run Object TargetGroupMarkeringActivityCreationRun). As a precondition, for example, the Target Group Life Cycle Status can be “Active”. Upon changing the status, for example, the Target Group Life Cycle Status can be set to “Blocked”. In some implementations, the Block action may be called from a user interface (UI) or from another business object.

The Check Addressability with Communication Medium enterprise service infrastructure action can check whether members of a Target Group can and may be addressed through a specific communication medium. In general, the action can check for each member of a Target Group whether Email, Letter or Fax address information is available and can check the value of a Contact Allowed attribute of an associated Customer. In some implementations, session log messages can be created for incomplete address data or if contacting a customer is not allowed. The Check Addressability with Communication Medium action can optionally include the following parameters, which can be action elements defined by the inline structure APCRM_S_TG_CHECK_ADDR_AC: CommunicationMediumTypeCode, IgnoreBlockedIndicator, and MemberAddressDeterminationMethodCode. CommunicationMediumTypeCode is a Communication Medium Type Code for which checks can be performed. CommunicationMediumTypeCode can be defined by a CommunicationMediumTypeCode data type. In some implementations, Communication Medium Type Codes Email (INT), Letter (LET) and Fax (FAX) are permitted. IgnoreBlockedIndicator indicates whether address data should be checked for target group members which are blocked. IgnoreBlockedIndicator can be defined by an Indicator data type, with a qualifier of “Blocked”. In general, blocked target group members may be members of a target group which may not be contacted for one or more reasons, such as the Contact Allowed code of the customer assigned to the target group member being “contact not allowed”, and/or the Address used to contact the target group member being blocked from usage. MemberAddressDeterminationMethodCode is a coded representation of a method by which member addresses are determined, and can be defined by a TargetGroupMemberAddressDeterminationMethodCode data type. In some implementations, the Check Addressability with Communication Medium action may be called from a user interface (UI) or from another business object.

The Create with Reference enterprise service infrastructure action can create a new Target Group with reference to an existing Target Group. In general, the Create with Reference action can create a new instance of a Target Group by referencing another Target Group (i.e., “Create by Copy”). The description and the members of the referenced Target Group, for example, can be copied to a new Target Group. When a Target Group is created, for example, the object may have the same members as an original Target Group. In some implementations, the Create with Reference action may be called from a user interface (UI) or from another business object.

The Flag as Obsolete enterprise service infrastructure action can mark a Target Group as obsolete. In some implementations, an obsolete Target Group may no longer be modified or used in marketing activities. The Flag as Obsolete action, for example, can set the Target Group Life Cycle Status to obsolete. As a precondition, for example, the Target Group Life Cycle Status can be “Active” or “Blocked”. In some implementations, the Flag as Obsolete action may be called from a user interface (UI) or from another business object.

The Intersect Members with Reference enterprise service infrastructure action can intersect referenced objects as Members with the Members of a current Target Group. In general, the references can be to root nodes of a business object (BO) Customer, to relationship nodes of a BO Customer, to root nodes of another BO Target Group or to Member nodes of another BO Target Group. Referenced objects can be resolved into lists of Members (customers/prospects or contact persons). These members can then be intersected with the members of a current Target Group. Members that are in both lists (i.e. the Target Group and the References) remain in the Target Group. For example, a Target Group can include a set of members {A,B,C}, with references to a set of members {B,C,D}. After performing an “intersect members” action, for example, the Target Group can include a set of members {B,C}. As a precondition, for example, the Life Cycle Status of a Target Group cannot be “obsolete”. Upon changing a Target Group object, for example, a list of Target Group Members can be modified and the attribute “MemberNumberValue” can be updated accordingly. In some implementations, the Intersect Members with Reference action may be called from a user interface (UI) or from another business object.

The Remove All Members enterprise service infrastructure action can remove all members from a current Target Group. All members can be removed, for example, when a Target Group needs to be rebuilt completely. As a precondition, for example, the Life Cycle Status of a Target Group cannot be “obsolete”. In general, all instances of a member node may be removed. In some implementations, the Remove All Members action may be called from a user interface (UI) or from another business object.

The Revoke Obsolescence enterprise service infrastructure action can undo a “Flag as obsolete” action. The Target Group Life Cycle Status, for example, can be set to “Blocked”. As a precondition, for example, the Target Group Life Cycle Status can be “Obsolete”. In some implementations, the Revoke Obsolescence action may be called from a user interface (UI) or from another business object.

The Subtract Members with Reference enterprise service infrastructure action can subtract referenced objects as Members from the Members of a current Target Group. In general, references can be to root nodes of a business object (BO) Customer, to relationship nodes of a BO Customer, to root nodes of another BO Target Group, or to Member nodes of another BO Target Group. Referenced objects can be resolved into lists of Members (customers/prospects or contact persons). These members can then be subtracted from the members of a current Target Group. Members that are in a list of references as well as in a Target Group can be deleted from the Target Group, whereas referenced Members that are not in the Target Group can be ignored. For example, a Target Group can include a set of members {A,B,C}, with references to a set of members {B,C,D}. After performing a “subtract” action, for example, the Target Group can include a set of members {A}. As a precondition, for example, the Life Cycle Status of a Target Group cannot be “obsolete”. Upon changing a Target Group object, for example, a list of Target Group Members can be modified and the attribute “MemberNumberValue” can be updated accordingly. In some implementations, the Subtract Members with Reference action may be called from a user interface (UI) or from another business object.

The Unblock enterprise service infrastructure action can unblock a Target Group and make it available for the creation of Marketing Activities. For example, an active Target Group may be specified for the creation of Marketing Activities by the Mass Data Run Object TargetGroupMarketingActivityCreationRun. The Target Group Life Cycle Status can be set to “Active”. As a precondition, for example, the Target Group Life Cycle Status can be “Blocked”. In some implementations, the Unblock action may be called from a user interface (UI) or from another business object.

The following queries can exist for a Target Group business object: Query By Elements, and SelectAll. The Query By Elements query is an elements query of the Target Group business object, and can include the following elements defined by the inline structure APCRM_S_TG_BY_ELEMENTS_QU: UUID, ID, SystemAdministrativeData, Description, MemberNumberValue, Status, and SearchText. UUID is a universally unique identifier of a Target Group, and can be defined by a UUID data type. ID is a human readable unique Identifier of a Target Group, and can be defined by a TargetGroupID data type. SystemAdministrativeData is a system administrative date (date and time, identity of creation and change of a Target Group), and can be defined by a SystemAdministrativeData data type. Description is a natural language description of a Target Group, and can be defined by a MEDIUM_Description data type. MemberNumberValue is a number of Members which currently belong to a Target Group, and can be defined by a NumberValue data type qualified by Member. Status is a status of a Target Group, and can include a Status/LifeCycleStatusCode which identifies the life cycle status of a Target Group. In general, marketing activities may not be performed for Target Groups with ActivationStatusCode of “Blocked” or “Obsolete”. An ActivationStatusCode of “Active” can be the default status for new Target Groups. An ActivationStatusCode of “Obsolete” can be a condition for deleting a Target Group. SearchText is free text containing one or several words (terms) to search for Target Groups. Search text can be defined by a SearchText data type. In some implementations, the different terms of the search text can be matched against a subset of the query parameters, and Target Group instances can be returned as if all the terms were specified in each query parameter. The SelectAll query provides the NodeIDs of all instances of the node. For example, the SelectAll query can be used to enable an initial loading of data for the Fast Search Infrastructure (FSI).

A Member is a customer, prospect or contact person to be contacted by means of marketing activities. In general, a Member of a Target Group can represent either a specific Customer or Prospect or a Contact Person of a specific Customer or Prospect. When the member is contacted by means of a marketing activity, for example, the associated customer or prospect or contact person is contacted.

The elements located directly at the node Member are defined by the data type TargetGroupMemberElements, and include the elements UUID, CustomerUUID, ContactPersonUUID, and AddressableChecklistResultStatusCode. UUID is a universally unique identifier of a Target Group, can be defined by a UUID data type, and can be an alternative key. CustomerUUID is a UUID of a Customer assigned to a Member, and can be defined by a UUID data type. ContactPersonUUID is a UUID of a Contact Person assigned to a Member, and can be defined by a UUID data type. AddressableChecklistResultStatusCode is a representation of an outcome of an addressability checks conducted for an Member. AddressableChecklistResultStatusCode can be defined by a ChecklistResultStatusCode data type.

The following composition relationships to subordinate nodes can exist: Member Information, with a cardinality of 1:1 (Composition is Disabled), Member Contact Information, with a cardinality of 1:C, and Member Overview, with a cardinality of 1:C (Composition is Disabled).

The following inbound aggregation relationships can exist: Contact Person (from the business object Business Partner/node Business Partner), with a cardinality of C:CN, and Customer (from the business object Customer/node Customer), with a cardinality of 1:CN. A Contact Person of a Customer or Prospect can be associated with a Target Group Member. An existing Customer or a prospective Customer (Prospect) can be associated with a Target Group Member. The following specialization associations for navigation to the node Target Group can exist: To Parent, with a target cardinality of 1, and To Root, with a target cardinality of 1.

Various integrity conditions can exist for a Member business object. In general, a Member instance cannot be maintained by setting individual attributes; instead, suitable maintenance actions can be provided at a Target Group (root) node. In general, Members in which an associated Customer has a ContactAllowedCode of “Not Allowed” in a Common node cannot be contacted by means of marketing activities.

The following enterprise service infrastructure actions can exist for a Member business object: Check Addressability With Communication Medium and Destroy. In general, the Check Addressability With Communication Medium action can check whether a current member can be contacted through a specified communication medium. The Check Addressability With Communication Medium action can optionally include the following parameters, which can be action elements defined by the inline structure APCRM_S_TG_MEMB_CHECK_ADDR_AC: CommunicationMediumTypeCode, IgnoreBlockedIndicator, and AddressDeterminationMethodCode. CommunicationMediumTypeCode is a Communication Medium Type Code for which checks can be performed, and can be defined by a CommunicationMediumTypeCode data type. Communication Medium Type Codes of “Email”, “Letter”, and “Fax” may be permitted, for example. IgnoreBlockedIndicator indicates whether address data should be checked for target group members which are blocked. IgnoreBlockedIndicator can be defined by an Indicator data type, qualified by Blocked. Blocked target group members are members of a target group which may not be contacted due to various reasons. For example, the contact allowed code of a customer assigned to a target group member may be “contact not allowed”. As another example, the address used to contact a target group member may be blocked from usage. AddressDeterminationMethodCode can be defined by a TargetGroupMemberAddressDeterminationMethodCode data type. In general, the Destroy action can destroy an object in accordance with specified data retention rules. Destruction of data, for example, can imply either physical deletion or anonymization. The Destroy action can be usable for Information Lifecycle Management; the object may not perform all business logic checks.

Member Information includes a general view about a member that can provide information about the member of a target group at a glance. The business partner data can be given, and in the case where a contact is given, then the contact information can be given. In general, the data can be grouped according to three values of MemberTypeCode: Corporate Account, Private Account, and Corporate Account with Contact Person.

The elements located directly at the node Member Information can be defined by the data type TargetGroupMemberInformationElements, and can include one or more of the optional elements MemberTypeCode, BusinessPartnerID, BusinessPartnerUUID BusinessPartnerStatus, BusinessPartnerName, BusinessPartnerContactAllowedCode, BusinessPartnerOrganisationName, BusinessPartnerProspectIndicator, ContactPersonUUID, ContactPersonInternalID, ContactPersonStatus, ContactPersonFormattedName, ContactPersonFunctionalTitleName, ContactPersonDepartmentName, MemberPersonFormOfAddressCode, MemberPersonGivenName, MemberPersonFamilyName, MemberPersonAcademicTitleCode, MemberPersonGenderCode, MemberPersonBirthDate, MemberFormattedName, MemberCorrespondenceLanguageCode, MemberPersonPreferredCommunicationMediumTypeCode, MemberFormattedAddressDescription, MemberCountryCode, MemberRegionCode, MemberStreetName, MemberHouseID, MemberStreetPostalCode, MemberCityName, MemberTelephoneFormattedNumberDescription, MemberTelephoneNormalisedNumberDescription, MemberTelephoneUsageDeniedIndicator, MemberFaxFormattedNumberDescription, MemberFaxNormalisedNumberDescription, MemberFaxUsageDeniedIndicator, MemberEmailURIDescription, MemberEmailNormalisedURIDescription, MemberEmailUsageDeniedIndicator, MemberLetterCheckResultCode, MemberTelephoneCheckResultCode, MemberFaxCheckResultCode, MemberEmailCheckResultCode, and MemberAddressUUID.

MemberTypeCode is a coded representation of a target group member, and can be defined by a TargetGroupMemberTypeCode data type. In some implementations, a target group member can have one of the following member type codes: Corporate Account, Private Account, or Corporate Account with Contact Person. BusinessPartnerID is an internal identifier for a business partner referenced by a target group member. BusinessPartnerID can be defined by a BusinessPartnerInternalID data type. In some implementations, a business partner may be a Prospect, a Customer (Organisation) or a Customer (Person). BusinessPartnerUUID is a universally unique identifier for a business partner referenced by a target group member. BusinessPartnerUUID can be defined by a UUID data type. In some implementations, a business partner may be a Prospect, a Customer (Organisation) or a Customer (Person). BusinessPartnerStatus is a status of a business partner referenced by a target group member. A BusinessPartnerStatus can include a BusinessPartnerStatus/LifeCycleStatusCode, which can represent the life cycle status of a customer referenced by a target group member, and can be defined by a PartyLifeCycleStatusCode data type. In some implementations, a business partner may be a Prospect, a Customer (Organisation) or a Customer (Person). BusinessPartnerName is a formatted name of a business partner referenced by a target group member. BusinessPartnerName can be defined by a LANGUAGEINDEPENDENT_LONG_Name data type. In some implementations, a business partner may be a Prospect, a Customer (Organisation) or a Customer (Person).

BusinessPartnerContactAllowedCode is a coded representation of a business partner that can be contacted, referenced by a target group member. BusinessPartnerContactAllowedCode can be defined by a ContactAllowedCode data type. In some implementations, a business partner may be a Prospect, a Customer (Organisation) or a Customer (Person). BusinessPartnerOrganisationName is a name of an organisation of a business partner referenced by a target group member. BusinessPartnerOrganisationName can be defined by an OrganisationName data type. In some implementations, a business partner may be a Prospect, a Customer (Organisation) or a Customer (Person). BusinessPartnerProspectIndicator is an indicator that specifies whether or not a business partner is a prospect. BusinessPartnerProspectIndicator can be defined by an Indicator data type. In some implementations, a business partner may be a Prospect, a Customer (Organisation) or a Customer (Person). ContactPersonUUID is a universally unique identifier of a contact person which represents a target group member. ContactPersonUUID can be defined by a UUID data type. The contact person, for example, can be a contact person of a customer assigned to a member. ContactPersonInternalID is an internal identifier for a contact person which represents a target group member. ContactPersonInternalID can be defined by a BusinessPartnerInternalID data type. The contact person, for example, can be a contact person of a customer assigned to a member. ContactPersonStatus is a status of a contact person which represents a target group member. A ContactPersonStatus can include a ContactPersonStatus/LifeCycleStatusCode, which can include a coded representation of the life cycle status of a contact person, and can be defined by a PartyLifeCycleStatusCode data type. The contact person, for example, can be a contact person of a customer assigned to a member.

ContactPersonFormattedName is a formatted name of a contact person which represents a target group member. ContactPersonFormattedName can be defined by a LANGUAGEINDEPENDENT_LONG_Name data type. The contact person, for example, can be a contact person of a customer assigned to a member. ContactPersonFunctionalTitleName is a functional title name of a contact person which represents a target group member. ContactPersonFunctionalTitleName can be defined by a LANGUAGEINDEPENDENT_MEDIUM_Name data type. The contact person, for example, can be a contact person of a customer assigned to a member. ContactPersonDepartmentName is a name for the department of a contact person which represents a target group member. ContactPersonDepartmentName can be defined by a LANGUAGEINDEPENDENT_MEDIUM_Name data type. The contact person, for example, can be a contact person of a customer assigned to a member. MemberPersonFormOfAddressCode is a coded representation of forms of address of a member, (e.g., Mr., Ms., etc.). MemberPersonFormOfAddressCode can be defined by a FormOfAddressCode data type. Depending on the type of member, for example, the data can be derived from information that is provided from a private account or a contact person of a corporate account. MemberPersonGivenName is a person's given name, and can be defined by a LANGUAGEINDEPENDENT_MEDIUM_Name data type. Depending on the type of member, for example, the data can be derived from information that is provided from a private account or a contact person of a corporate account. MemberPersonFamilyName is a person's family name, and can be defined by a LANGUAGEINDEPENDENT_MEDIUM_Name data type. Depending on the type of member, for example, the data can be derived from information that is provided from a private account or a contact person of a corporate account.

MemberPersonAcademicTitleCode is a coded representation of an academic title of a person, and can be defined by an AcademicTitleCode. Depending on the type of member, for example, the data can be derived from information that is provided from a private account or a contact person of a corporate account. MemberPersonGenderCode is a coded representation of a person's gender, and can be defined by a GenderCode. Depending on the type of member, for example, the data can be derived from information that is provided from a private account or a contact person of a corporate account. MemberPersonBirthDate is the point in time at which a person is born, and can be defined by a Date. Depending on the type of member, for example, the data can be derived from information that is provided from a private account or a contact person of a corporate account. MemberFormattedName is a formatted name of a target group member, and can be defined by a LANGUAGEINDEPENDENT_LONG_Name data type. Depending on the type of member, for example, the data can be derived from information that is provided from a private account or a contact person of a corporate account. MemberCorrespondenceLanguageCode is a coded representation of a correspondence language of a target group member, and can be defined by a LanguageCode data type. Depending on the type of member, for example, the data can derived from communication data of a corporate account, person data of a private account, or person data of a corporate account's contact person. MemberPersonPreferredCommunicationMediumTypeCode is a coded representation of the type of preferred communication medium for a person that is a target group member. MemberPersonPreferredCommunicationMediumTypeCode can be defined by a CommunicationMediumTypeCode data type. Depending on the type of member, for example, the data can be derived from information that is provided from a private account or a contact person of a corporate account.

MemberFormattedAddressDescription is a formatted address of a target group member, and can be defined by a LANGUAGEINDEPENDENT_MEDIUM_Description data type. Depending on the type of member, for example, the data can be derived from information that is provided from a private account or a contact person of a corporate account. MemberCountryCode is a coded representation of the country of a target group member, and can be defined by a CountryCode data type. If no contact person is associated with a target group member, for example, the data can be derived from a customer associated with the member. If a customer and a contact person are associated with a member, for example, the data can be derived from the relationship between the customer and the contact person which are both associated with the member. MemberRegionCode is a coded representation of the region of a target group member, and can be defined by a RegionCode data type. If no contact person is associated with a target group member, for example, the data can be derived from a customer associated with the member. If a customer and a contact person are associated with a member, for example, the data can be derived from the relationship between the customer and the contact person which are both associated with the member. MemberStreetName is the name of a street of a target group member, and can be defined by a StreetName data type. If no contact person is associated with a target group member, for example, the data can be derived from a customer associated with the member. If a customer and a contact person are associated with a member, for example, the data can be derived from the relationship between the customer and the contact person which are both associated with the member. MemberHouseID is an identifier for a house of a target group member, and can be defined by a HouseID data type. If no contact person is associated with a target group member, for example, the data can be derived from a customer associated with the member. If a customer and a contact person are associated with a member, for example, the data can be derived from the relationship between the customer and the contact person which are both associated with the member.

MemberStreetPostalCode is a coded representation of a postcode for a street of a target group member, and can be defined by a PostalCode data type. If no contact person is associated with a target group member, for example, the data can be derived from a customer associated with the member. If a customer and a contact person are associated with a member, for example, the data can be derived from the relationship between the customer and the contact person which are both associated with the member. MemberCityName is a name of a city of a target group member, and can be defined by a LANGUAGEINDEPENDENT_MEDIUM_Name data type. If no contact person is associated with a target group member, for example, the data can be derived from a customer associated with the member. If a customer and a contact person are associated with a member, for example, the data can be derived from the relationship between the customer and the contact person which are both associated with the member. MemberTelephoneFormattedNumberDescription is a description of a formatted telephone number of a target group member, and can be defined by a LANGUAGEINDEPENDENT_SHORT_Description data type. Depending on the type of member, for example, the data can be derived from information that is provided from a corporate account, private account, or a contact person relationship of a corporate account. MemberTelephoneNormalisedNumberDescription is a description of a normalized telephone number of a target group member, and can be defined by a LANGUAGEINDEPENDENT_SHORT_Description data type. Depending on the type of member, for example, the data can be derived from information that is provided from a corporate account, private account, or a contact person relationship of a corporate account. MemberTelephoneUsageDeniedIndicator is an indicator that specifies whether or not the usage of fax is denied by a target group member.

MemberTelephoneUsageDeniedIndicator can be defined by an Indicator data type. Depending on the type of member, for example, the data can be derived from information that is provided from a corporate account, private account, or a contact person relationship of a corporate account. MemberFaxFormattedNumberDescription is a description of a formatted fax number of a target group member, and can be defined by a LANGUAGEINDEPENDENT_SHORT_Description data type. Depending on the type of member, for example, the data can be derived from information that is provided from a corporate account, private account, or a contact person relationship of a corporate account. MemberFaxNormalisedNumberDescription is a description of a normalized fax number of a target group member, and can be defined by a LANGUAGEINDEPENDENT_SHORT_Description data type. Depending on the type of member, for example, the data can be derived from information that is provided from a corporate account, private account, or a contact person relationship of a corporate account. MemberFaxUsageDeniedIndicator is an indicator that specifies whether or not the usage of fax is denied by a target group member. MemberFaxUsageDeniedIndicator can be defined by an Indicator data type. Depending on the type of member, for example, the data can be derived from information that is provided from a corporate account, private account, or a contact person relationship of a corporate account. MemberEmailURIDescription is a description of the uniform resource identifier for e-mail of a target group member. MemberEmailURIDescription can be defined by a LANGUAGEINDEPENDENT_SHORT_Description data type. Depending on the type of member, for example, the data can be derived from information that is provided from a corporate account, private account, or a contact person relationship of a corporate account. MemberEmailNormalisedURIDescription is a description of the uniform resource identifier for a normalized e-mail of a target group member.

MemberEmailNormalisedURIDescription can be defined by a LANGUAGEINDEPENDENT_SHORT_Description data type. Depending on the type of member, for example, the data can be derived from information that is provided from a corporate account, private account, or a contact person relationship of a corporate account. MemberEmailUsageDeniedIndicator is an indicator that specifies whether or not the usage of e-mail is denied for a target group member. MemberEmailUsageDeniedIndicator can be defined by an Indicator data type. Depending on the type of member, for example, the data can be derived from information that is provided from a corporate account, private account, or a contact person relationship of a corporate account. MemberLetterCheckResultCode is a coded representation of the check result of whether or not a target group member can be contacted by letter. MemberLetterCheckResultCode can be defined by a TargetGroupMemberLetterAddressabilityCode data type. Depending on the type of member, for example, the data can be derived from information that is provided from a corporate account, private account, or a contact person relationship of a corporate account. The letter check result of a target group member can have a value of “Successful”, “Unsuccessful—Account Not Active”, “Unsuccessful—Contact Person Not Active”, “Unsuccessful—Account Not Allowed to Be Contacted”, “Unsuccessful—Contact Not Allowed to Be Contacted”, “Unsuccessful—Valid Postal Address Missing”, or “Unsuccessful—Contact Not Assigned to Account”.

MemberTelephoneCheckResultCode is a coded representation of a check result of whether or not a target group member can be contacted by phone. MemberTelephoneCheckResultCode can be defined by a TargetGroupMemberTelephoneAddressabilityCode data type. Depending on the type of member, for example, the data can be derived from information that is provided from a corporate account, private account, or a contact person relationship of a corporate account. The telephone check result of a target group member can have a value of “Successful”, “Unsuccessful—Account Not Active”, “Unsuccessful—Contact Person Not Active”, “Unsuccessful—Account Not Allowed to Be Contacted”, “Unsuccessful—Contact Not Allowed to Be Contacted”, “Unsuccessful—Telephone Number Missing”, “Unsuccessful—Telephone Number Invalid”, or “Unsuccessful—Contact Not Assigned to Account”. MemberFaxCheckResultCode is a coded representation of a check result of whether or not a target group member can be contacted by fax. MemberFaxCheckResultCode can be defined by a TargetGroupMemberFacsimileAddressabilityCode data type. Depending on the type of member, for example, the data can be derived from information that is provided from a corporate account, private account, or a contact person relationship of a corporate account. The fax check result of a target group member can have a value of “Successful”, “Unsuccessful—Account Not Active”, “Unsuccessful—Contact Person Not Active”, “Unsuccessful—Account Not Allowed to Be Contacted”, “Unsuccessful—Contact Not Allowed to Be Contacted”, “Unsuccessful—Facsimile Number Missing”, “Unsuccessful—Facsimile Number Invalid”, or “Unsuccessful—Contact Not Assigned to Account”. MemberEmailCheckResultCode is a coded representation of a check result of whether or not a target group member can be contacted by e-mail.

MemberEmailCheckResultCode can be defined by a TargetGroupMemberEmailAddressabilityCode data type. Depending on the type of member, for example, the data can be derived from information that is provided from a corporate account, private account, or a contact person relationship of a corporate account. The e-mail check result of a target group member can have a value of “Successful”, “Unsuccessful—Account Not Active”, “Unsuccessful—Contact Person Not Active”, “Unsuccessful—Account Not Allowed to Be Contacted”, “Unsuccessful—Contact Not Allowed to Be Contacted”, “Unsuccessful—Email Address Missing”, “Unsuccessful—Email Address Invalid”, or “Unsuccessful—Contact Not Assigned to Account”. MemberAddressUUID is a universally unique identifier for an address referenced by a target group member. MemberAddressUUID can be defined by a UUID data type. The address can be either related to an account (e.g., an organisation or person) or to a contact person relationship of a corporate account. A specialization association for navigation can exist to the node Member: To Parent, with a target cardinality of 1. A specialization association for navigation can exist to the node Target Group To Root, with a target cardinality of 1.

A Query By Elements query can exist for Member Information. The Query By Elements query can return a list of member information according to specified selection elements, which may include Member UUID, Member Letter Addressable Indicator, Member Telephone Addressable Indicator, Member Fax Addressable Indicator, and Member E-Mail Addressable Indicator. The query elements can by defined by the data type TargetGroupMemberInformationElementsQueryElements, and can include MemberUUID, MemberLetterAddressableIndicator, MemberTelephoneAddressableIndicator, MemberFaxAddressableIndicator, and MemberEmailAddressableIndicator elements. MemberUUID is a universally unique identifier of a target group member, and can be defined by a UUID data type. MemberLetterAddressableIndicator is an indicator that specifies whether or not a target group member can be addressable by letter. MemberLetterAddressableIndicator can be defined by an Indicator data type. In some implementations, when this indicator is set, target member instances addressable by letter are selected. MemberTelephoneAddressableIndicator is an indicator that specifies whether or not a target group member can be addressable by telephone. MemberTelephoneAddressableIndicator can be defined by an Indicator data type. In some implementations, when this indicator is set, target member instances addressable by telephone are selected. MemberFaxAddressableIndicator is an indicator that specifies whether or not a target group member can be addressable by fax. MemberFaxAddressableIndicator can be defined by an Indicator data type. In some implementations, when this indicator is set, target member instances addressable by fax are selected. MemberEmailAddressableIndicator is an indicator that specifies whether or not a target group member can be addressable by e-mail. MemberEmailAddressableIndicator can be defined by an Indicator data type. In some implementations, when this indicator is set, target member instances addressable by e-mail are selected.

Member Contact Information (Transformation Node) can include information for contacting a Target Group Member through multiple communication media (e.g., e-mail, letter, facsimile, telephone, etc.). In general, Member Contact Information can unify access to scattered, interdependent address data, can consider access hierarchies (e.g. the NonVerbalCommunicationLanguage of a Contact Person can override the language of a corresponding Customer), and can include business logic (e.g. phone numbers which are blocked are not exposed).

Member Contact Information can be compiled from various sources. For example, if a member is a Customer/Prospect that is an Organisation or Person, and no Contact Person is maintained, the sources may include ContactAllowedCode, CustomerRootCommonContactAllowedCode, ProspectIndicator (e.g., set to true if BO CustomerRoleRoleCode=Prospect exists), NonVerbalCommunicationLanguageCode, business object (BO) CustomerCommonPersonNonVerbalCommunicationLanguageCode, PreferredCommunicationMediumTypeCode, BO CustomerAddressInformationCommunicationPreference, PreferredCommunicationMediumTypeCode, OrganisationInternalID, BO CustomerInternalID, OrganisationFormattedName, BO CustomerCommonBusinessPartnerFormattedName, OrganisationFirstLineName, BO CustomerCommonOrganisationNameFirstLineName, OrganisationSecondLineName, BO CustomerCommonOrganisationNameSecondLineName, OrganizationThirdLineName, BO CustomerCommonOrganisationNameThirdLineName, OrganisationFourthLineName, BO CustomerCommonOrganisationNameFourthLineName, PersonInternalID, BO CustomerInternalID, PersonAcademicTitleCode, BO CustomerCommonPersonNameAcademicTitleCode, PersonAcademicTitleName, BO CustomerCommonPersonNameAcademicTitleName, PersonGivenName, BO CustomerCommonPersonNameGivenName, PersonFormattedName, BO CustomerCommonPersonNameFamilyName, PersonGenderCode, BO CustomerCommonPersonGenderCode, PersonBirthDate, BO CustomerCommonPersonBirthDate, PostalAddressCountryCode, BO CustomerAddressInformationAddressPostalAddressCountryCode, PostalAddressRegionCode, BO CustomerAddressInformationAddressPostalAddressRegionCode, PostalAddressStreetPostalCode, BO CustomerAddressInformationAddressPostalAddressStreetPostalCode, PostalAddressCityName, BO CustomerAddressInformationAddressPostalAddressCityName, PostalAddressStreetName, BO CustomerAddressInformationAddressPostalAddressStreetName, PostalAddressHouseID, BO CustomerAddressInformationAddressPostalAddressHouseID, FormattedAddressAddressFormattedName, BO CustomerCommonCommonFormattedDefaultAddress, FormattedAddressFormattedPostalAddressDescription, BO CustomerCommonCommonFormattedDefaultAddress, EmailURI, BO CustomerAddressInformationAddressE-mail, TelephoneNumber, BO CustomerAddressInformationAddressTelephone, FacsimileNumber, BO CustomerAddressInformationAddressFacsimile, PostalRegulationsCompliantAddressFirstLine, BO CustomerCommonCommonFormattedDefaultAddress, PostalRegulationsCompliantAddressFirstLine, PostalRegulationsCompliantAddressSecondLine, BO CustomerCommonCommonFormattedDefaultAddress, PostalRegulationsCompliantAddressSecondLine, PostalRegulationsCompliantAddressThirdLine, BO CustomerCommonCommonFormattedDefaultAddress, PostalRegulationsCompliantAddressThirdLine, PostalRegulationsCompliantAddressFourthLine, BO CustomerCommonCommonFormattedDefaultAddress, PostalRegulationsCompliantAddressFourthLine, PostalRegulationsCompliantAddressFifthLine, BO CustomerCommonCommonFormattedDefaultAddress, PostalRegulationsCompliantAddressFifthLine, PostalRegulationsCompliantAddressSixthLine, BO CustomerCommonCommonFormattedDefaultAddress, PostalRegulationsCompliantAddressSixthLine, PostalRegulationsCompliantAddressSeventhLine, BO CustomerCommonCommonFormattedDefaultAddress, PostalRegulationsCompliantAddressSeventhLine, PostalRegulationsCompliantAddressEighthLine, BO CustomerCommonCommonFormattedDefaultAddress, PostalRegulationsCompliantAddressEighthLine, PostalRegulationsCompliantAddressNinthLine, BO CustomerCommonCommonFormattedDefaultAddress, PostalRegulationsCompliantAddressNinthLine, PostalRegulationsCompliantAddressTenthLine, BO CustomerCommonCommonFormattedDefaultAddress, and PostalRegulationsCompliantAddressTenthLine.

If a member is a Customer/Prospect with a corresponding Contact Person, for example, Member Contact Information can be compiled from sources including ContactAllowedCode, CustomerRootCommonContactAllowedCode, ProspectIndicator (e.g., set to true if BO CustomerRoleRoleCode=Prospect exists), NonVerbalCommunicationLanguageCode, ContactPersonCommonPersonNonVerbalCommunicationLanguageCode, PreferredCommunicationMediumTypeCode, ContactPersonAddressInformationCommunicationPreference, PreferredCommunicationMediumTypeCode, SalutationText, ContactPersonCommonSalutationText, OrganisationInternalID, BO CustomerInternalID, OrganisationFormattedName, BO CustomerCommonBusinessPartnerFormattedName, OrganisationFirstLineName, BO CustomerCommonOrganisationNameFirstLineName, OrganisationSecondLineName, BO CustomerCommonOrganisationNameSecondLineName, OrganizationThirdLineName, BO CustomerCommonOrganisationNameThirdLineName, OrganisationFourthLineName, BO CustomerCommonOrganisationNameFourthLineName, PersonInternalID, RelationshipRelationshipBusinessPartnerInternalID, PersonAcademicTitleCode, RelationShipContactPersonRelationshipContactPersonWorkplaceAddress, PersonNameAcademicTitleCode, PersonAcademicTitleName, RelationShipContactPersonCommonPersonNameAcademicTitleName, PersonGivenName, RelationShipContactPersonRelationshipContactPersonWorkplaceAddress, PersonNameGivenName, PersonFamilyName, RelationShipContactPersonRelationshipContactPersonWorkplaceAddress, PersonNameFamilyName, PersonFormattedName, RelationShipContactPersonRelationshipContactPersonWorkplaceAddress, PersonNameFamilyName, PersonGenderCode, RelationShipContactPersonRelationshipContactPersonWorkplaceAddress, PersonNameGenderCode, PersonBirthDate, RelationShipContactPersonRelationshipContactPersonWorkplaceAddress, PersonNameBirthDate, PostalAddressCountryCode, RelationShipContactPersonWorkplaceAddressAddressCountryCode, PostalAddressRegionCode, RelationShipContactPersonWorkplaceAddressAddressRegionCode, PostalAddressStreetPostalCode, RelationShipContactPersonWorkplaceAddressAddress, PostalAddressStreetPostalCode, PostalAddressCityName, RelationShipContactPersonWorkplaceAddressAddress, PostalAddressCityName, PostalAddressStreetName, RelationShipContactPersonWorkplaceAddressAddress, PostalAddressStreetName, PostalAddressHouseID, RelationShipContactPersonWorkplaceAddressAddress, PostalAddressHouseID, FormattedAddressAddressFormattedName, RelationShipContactPersonWorkplaceAddressAddress, PostalAddress, FormattedAddressFormattedPostalAddressDescription, RelationShipContactPersonWorkplaceAddressAddress, PostalAddress, EmailURI, RelationShipContactPersonWorkplaceAddressAddressE-mail, TelephoneNumber, RelationShipContactPersonWorkplaceAddressTelephone, FacsimileNumber, RelationShipContactPersonWorkplaceAddressFacsimile, PostalRegulationsCompliantAddressFirstLine, RelationShipContactPersonWorkplaceAddressAddress, PostalRegulationsCompliantAddressFirstLine, PostalRegulationsCompliantAddressSecondLine, RelationShipContactPersonWorkplaceAddressAddress, PostalRegulationsCompliantAddressSecondLine, PostalRegulationsCompliantAddressThirdLine, RelationShipContactPersonWorkplaceAddressAddress, PostalRegulationsCompliantAddressThirdLine, PostalRegulationsCompliantAddressFourthLine, RelationShipContactPersonWorkplaceAddressAddress, PostalRegulationsCompliantAddressFourthLine, PostalRegulationsCompliantAddressFifthLine, RelationShipContactPersonWorkplaceAddressAddress, PostalRegulationsCompliantAddressFifthLine, PostalRegulationsCompliantAddressSixthLine, RelationShipContactPersonWorkplaceAddressAddress, PostalRegulationsCompliantAddressSixthLine, PostalRegulationsCompliantAddressSeventhLine, RelationShipContactPersonWorkplaceAddressAddress, PostalRegulationsCompliantAddressSeventhLine, PostalRegulationsCompliantAddressEighthLine, RelationShipContactPersonWorkplaceAddressAddress, PostalRegulationsCompliantAddressEigthLine, PostalRegulationsCompliantAddressNinthLine, RelationShipContactPersonWorkplaceAddressAddress, PostalRegulationsCompliantAddressNinthLine, PostalRegulationsCompliantAddressTenthLine, RelationShipContactPersonWorkplaceAddressAddress, and PostalRegulationsCompliantAddressTenthLine.

The elements located directly at the node Member Contact Information can be defined by the data type TargetGroupMemberContactInformationElements. These elements can include ContactAllowedCode, ProspectIndicator, NonVerbalCommunicationLanguageCode, PreferredCommunicationMediumTypeCode, FormOfAddressCode, FormattedName, FormattedPostalAddressDescription, CustomerUUID, CustomerInternalID, CustomerFormattedName, ContactPersonUUID, ContactPersonInternalID, ContactPersonFormattedName, ContactPersonFormattedPrivatePostalAddressDescription, Organisation, Person, PostalAddress, and Communication.

ContactAllowedCode is a coded description of contact permission, and can be defined by a ContactAllowedCode data type. The attribute can include a Contact Allowed Code of a Customer associated with a Target Group Member. ProspectIndicator can be defined by an Indicator data type, qualified by Prospect. The customer associated with a Target Group member, for example, is a Prospect. NonVerbalCommunicationLanguageCode is an optional coded representation of a language used for nonverbal communication. NonVerbalCommunicationLanguageCode can be defined by a LanguageCode data type, qualified by Communication. The attribute can include the NonverbalCommunicationLanguageCode of a Contact Person assigned with a Target Group Member. If the nonverbal communication language of the Contact Person is not maintained, for example, or if no Contact Person is associated with the Target Group Member, the attribute can include the NonverbalCommunicationLanguageCode of a Customer assigned to the Target Group Member. PreferredCommunicationMediumTypeCode is an optional coded representation of a Communication Medium (e.g. Email, Letter, Fax, etc.) through which a Target Group Member would prefer to be contacted. PreferredCommunicationMediumTypeCode can be defined by a CommunicationMediumTypeCode data type, qualified by Preferred. If a Target Group Member represents a Customer/Prospect (Organisation or Person) and an associated Contact Person, for example, the attribute can include a preferred communication medium of a contact person (provided the attribute is maintained for the Contact Person).

If the Target Group Member represents a Customer/Prospect without a specifically associated Contact Person, for example the attribute can include a preferred communication medium of the Customer/Prospect. FormOfAddressCode is an optional coded representation of the form of an address, and can be defined by a FormOfAddressCode data type. FormattedName is a Formatted Name of a Target Group Member. FormattedName can be defined by a LANGUAGEINDEPENDENT_LONG_Name data type, qualified by Formatted. FormattedPostalAddressDescription is an optional Formatted Postal Address of a Target Group Member, in one Line. FormattedPostalAddressDescription can be defined by a LANGUAGEINDEPENDENT_MEDIUM_Description data type, qualified by FormattedPostalAddress. CustomerUUID is a universally unique identifier of a Customer to which a Target Group Member belongs. CustomerUUID can be defined by a UUID data type. A Customer, for example, may be a Prospect, a Customer (Organisation), or a Customer (Person). CustomerInternalID is an Internal ID of a Customer to which a Target Group member belongs. CustomerInternalID can be defined by a BusinessPartnerInternalID data type. A Customer, for example, may be a Prospect, a Customer (Organisation), or a Customer (Person). CustomerFormattedName is an optional Formatted Name of a Customer to which a Target Group Member belongs. CustomerFormattedName can be defined by a LANGUAGEINDEPENDENT_LONG_Name, qualified by Formatted.

A Customer, for example, may be a Prospect, a Customer (Organisation), or a Customer (Person). ContactPersonUUID is an optional universally unique identifier of a Contact Person which represents a Target Group Member. ContactPersonUUID can be defined by a UUID data type. The Contact Person, for example, may be a Contact Person of a Customer assigned to a member. ContactPersonInternalID is an optional identifier of a Contact Person which represents a Target Group Member. ContactPersonInternalID can be defined by a BusinessPartnerInternalID data type. The Contact Person, for example, may be a Contact Person of a Customer assigned to a member. ContactPersonFormattedName is an optional Formatted Name of a Contact Person which represents a Target Group Member. ContactPersonFormattedName can be defined by a LANGUAGEINDEPENDENT_LONG_Name data type, qualified by PersonFormatted. The Contact Person, for example, may be a Contact Person of the Customer assigned to the member. ContactPersonFormattedPrivatePostalAddressDescription is an optional formatted private postal address of a contact person for a target group member, in one line. ContactPersonFormattedPrivatePostalAddressDescription can be defined by a LANGUAGEINDEPENDENT_MEDIUM_Description data type.

Organisation is an optional group of elements included in Target Group Member Contact Information that belong to an Organisation which is associated with a Target Group Member. In general, an Organisation can be a Customer (Organisation) that is associated with a Target Group Member. In some implementations, if no Customer (Organisation) is associated with a member, this substructure may not be maintained. Organisation is a substructure of the Elements structure of the Member Contact Information Transformation Node of the business object (BO) Target Group, and can be defined by a TargetGroupMemberContactInformationOrganisationElements business object data type. Organisation elements can optionally include Organisation/InternalID, Organisation/FormattedName, Organisation/FirstLineName, Organisation/SecondLineName, Organisation/ThirdLineName, and Organisation/FourthLineName. Organisation/InternalID is an internal ID of an Organisation associated with a Target Group member, and can be defined by a BusinessPartnerInternalID data type. Organisation/FormattedName is a Formatted Name of an Organisation associated with a Target Group Member. Organisation/FormattedName can be defined by a LANGUAGEINDEPENDENT_LONG_Name, qualified by Formatted. Organisation/FirstLineName is a first line of a Name of an Organisation associated with a Target Group Member, and can be defined by a MEDIUM_Name data type. Organisation/SecondLineName is a second line of a Name of an Organisation associated with a Target Group Member, and can be defined by a MEDIUM_Name data type. Organisation/ThirdLineName is a third line of a Name of an Organisation associated with a Target Group Member, and can be defined by a MEDIUM_Name data type. Organisation/FourthLineName is a fourth line of a Name of an Organisation associated with a Target Group Member, and can be defined by a MEDIUM_Name data type.

Person is an optional group of elements included in Target Group Member Contact Information that belong to a Person which is associated with a Target Group Member. In general, a Person can be a Customer (Person) that is associated with a Target Group Member, or a Contact Person of a Customer (Organisation) that is associated with the Target Group Member. In some implementations, if no Person is associated with a member, this substructure may not be maintained. Person is a substructure of the Elements structure of the Member Contact Information Transformation Node of the business object (BO) Target Group, and can be defined by a TargetGroupMemberContactInformationPersonElements business object data type. Person elements can optionally include Person/InternalID, Person/FunctionalTitleName, Person/DepartmentName, Person/AcademicTitleCode, Person/GivenName, Person/FamilyName, Person/FormattedName, Person/GenderCode, and Person/BirthDate. Person/InternalID is an internal Identifier of a Person assigned to a Target Group Member, and can be defined by a BusinessPartnerInternalID data type. The Person, for example, can be a Customer (Person) or a Contact Person of a Customer (Organisation). Person/FunctionalTitleName is a description of a function of a person, for example, as contact person in a company. Person/FunctionalTitleName can be defined by a LANGUAGEINDEPENDENT_MEDIUM_Name data type, qualified by FunctionalTitle. Person/DepartmentName is a name of a department of a person associated with a Target Group Member in a company.

Person/DepartmentName can be defined by a LANGUAGEINDEPENDENT_MEDIUM_Name data type, qualified by Department. Person/AcademicTitleCode is a code for an academic title of a person associated with a Target Group Member. Person/AcademicTitleCode can be defined by an AcademicTitleCode data type. Person/GivenName is a given name of a person associated with a Target Group Member. Person/GivenName can be defined by a LANGUAGEINDEPENDENT_MEDIUM_Name data type, with a qualifier of Given. Person/FamilyName is a family name of a person associated with a Target Group Member. Person/FamilyName can be defined by a LANGUAGEINDEPENDENT_MEDIUM_Name data type, qualified by Family. Person/FormattedName is a formatted name of a person associated with a Target Group Member. Person/FormattedName can be defined by a LANGUAGEINDEPENDENT_LONG_Name data type, qualified by Formatted. Person/GenderCode is a coded representation of a Gender of a Person associated with a Target Group Member, and can be defined by a GenderCode data type. Person/BirthDate is a birth date of a Person associated with a Target Group Member. Person/BirthDate can be defined by a Date data type, qualifier by Birth.

PostalAddress is a postal address through which a Target Group member may be contacted. In some implementations, if no Contact Person is associated with a Target Group Member, PostalAddress data can be derived from a Customer associated with a Member. In some implementations, if a Customer and a Contact Person are associated with a Target Group Member, PostalAddress data can be derived from a Relationship between a Customer and a Contact Person which are both associated with a Member. PostalAddress is a substructure of the Elements structure of the Member Contact Information Transformation Node of the business object (BO) Target Group, and can be defined by a TargetGroupMemberContactInformationPostalAddressElements business object data type. PostalAddress elements can optionally include PostalAddress/OriginCode, PostalAddress/CountryCode, PostalAddress/RegionCode, PostalAddress/StreetPostalCode, PostalAddress/CityName, PostalAddress/StreetName, PostalAddress/HouseID, and PostalAddress/PostalRegulationsCompliantAddress. PostalAddress/OriginCode is a coded representation of an origin of an address of a target group member, and can be defined by a TargetGroupMemberAddressOriginCode data type. PostalAddress/CountryCode is a country code of an address in accordance with ISO 3166-1. PostalAddress/CountryCode can be m defined by a CountryCode data type. PostalAddress/RegionCode is a code for a region of a country in an address. This specification is sometimes part of an address, for example, in the United States.

PostalAddress/RegionCode can be defined by a RegionCode data type. PostalAddress/StreetPostalCode is a postal code in a street address. Rules for creating postal codes, for example, can be by country. PostalAddress/StreetPostalCode can be defined by a PostalCode, qualified by Street. PostalAddress/CityName is a name of a city in an address. PostalAddress/CityName can be defined by a LANGUAGEINDEPENDENT_MEDIUM_Name data type, qualified by City. PostalAddress/StreetName is a name of a street in an address, and can be defined by a StreetName data type. PostalAddress/HouseID is a house number for a street in an address, and can be defined by a HouseIDdata type. PostalAddress/PostalRegulationsCompliantAddress is a Postal Address of a Target Group Member, compliant with postal regulations of the country of origin. PostalAddress/PostalRegulationsCompliantAddress can be defined by a TargetGroupMemberContactInformationPostalRegulationsCompliantAddressElements data type. TargetGroupMemberContactInformationPostalRegulationsCompliantAddressElements can optionally include PostalAddress/PostalRegulationsCompliantAddress/FirstLine, PostalAddress/PostalRegulationsCompliantAddress/SecondLine, PostalAddress/PostalRegulationsCompliantAddress/ThirdLine, PostalAddress/PostalRegulationsCompliantAddress/FourthLine, PostalAddress/PostalRegulationsCompliantAddress/FifthLine, PostalAddress/PostalRegulationsCompliantAddress/SixthLine, PostalAddress/PostalRegulationsCompliantAddress/SeventhLine, PostalAddress/PostalRegulationsCompliantAddress/EighthLine, PostalAddress/PostalRegulationsCompliantAddress/NinthLine, and PostalAddress/PostalRegulationsCompliantAddress/TenthLine elements.

PostalAddress/PostalRegulationsCompliantAddress/FirstLine is a first line of an address, and can be defined by a PostalRegulationsCompliantAddressLine data type. PostalAddress/PostalRegulationsCompliantAddress/SecondLine is a second line of an address, and can be defined by a PostalRegulationsCompliantAddressLine data type. PostalAddress/PostalRegulationsCompliantAddress/ThirdLine is a third line of an address, and can be defined by a PostalRegulationsCompliantAddressLine data type. PostalAddress/PostalRegulationsCompliantAddress/FourthLine is a fourth line of an address, and can be defined by a PostalRegulationsCompliantAddressLine data type. PostalAddress/PostalRegulationsCompliantAddress/FifthLine is a fifth line of an address, and can be defined by a PostalRegulationsCompliantAddressLine data type. PostalAddress/PostalRegulationsCompliantAddress/SixthLine is a sixth line of an address, and can be defined by a PostalRegulationsCompliantAddressLine data type. PostalAddress/PostalRegulationsCompliantAddress/SeventhLine is a seventh line of an address, and can be defined by a PostalRegulationsCompliantAddressLine data type. PostalAddress/PostalRegulationsCompliantAddress/EighthLine is an eighth line of an address, and can be defined by a PostalRegulationsCompliantAddressLine data type. PostalAddress/PostalRegulationsCompliantAddress/NinthLine is a ninth line of an address, and can be defined by a PostalRegulationsCompliantAddressLine data type. PostalAddress/PostalRegulationsCompliantAddress/TenthLine is a tenth line of an address, and can be defined by a PostalRegulationsCompliantAddressLine data type.

Communication is an optional group of elements including communication data for contacting a Target Group Member by Email, Facsimile or Telephone. In some implementations, if no Contact Person is associated with a Target Group Member, the data may be derived from a Customer associated with a Member. In some implementations, if a Customer and a Contact Person are associated with a member, the data may be derived from a Relationship between a Customer and a Contact Person which are both associated with a Member. Communication is a substructure of the Elements structure of the Member Contact Information Transformation Node of the business object (BO) Target Group, and can be defined by a TargetGroupMemberContactInformationCommunicationElements business object data type. Communication elements can include Communication/TelephoneFormattedNumberDescription, Communication/TelephoneNormalisedNumberDescription, Communication/TelephoneUsageDeniedIndicator, Communication/FacsimileFormattedNumberDescription, Communication/FacsimileNormalisedNumberDescription, Communication/FacsimileUsageDeniedIndicator, Communication/EmailURI, and Communication/EmailUsageDeniedIndicator.

Communication/TelephoneFormattedNumberDescription is an optional formatted default phone number of a Target Group Member, and can be defined by a LANGUAGEINDEPENDENT_SHORT_Description data type. Communication/TelephoneNormalisedNumberDescription is an optional normalized default phone number of a Target Group Member, and can be defined by a LANGUAGEINDEPENDENT_SHORT_Description data type. Communication/TelephoneUsageDeniedIndicator indicates whether a telephone number may be used to contact a Target group Member. Communication/TelephoneUsageDeniedIndicator can be defined by an Indicator, qualified by Denied. Communication/FacsimileFormattedNumberDescription is an optional formatted default fax number of a Target Group Member, and can be defined by a LANGUAGEINDEPENDENT_SHORT_Description data type. Communication/FacsimileNormalisedNumberDescription is an optional normalized default fax number of a Target Group Member, and can be defined by a LANGUAGEINDEPENDENT_SHORT_Description data type. Communication/FacsimileUsageDeniedIndicator indicates whether a facsimile number may be used to contact a Target group Member. Communication/FacsimileUsageDeniedIndicator can be defined by an Indicator data type, qualified by Denied. Communication/EmailURI is an optional default e-mail address of a Target Group Member, and can be defined by an EmailURI data type. Communication/EmailUsageDeniedIndicator indicates whether an email address may be used to contact a Target Group Member. Communication/EmailUsageDeniedIndicator can be defined by an Indicator data type, qualified by Denied. A specialization association for navigation to the node Member can exist: To Parent, with a target cardinality of 1. A specialization association for navigation to the node Target Group can exist: To Root, with a target cardinality of 1.

Member Overview provides a general view on a Target Group Member, and can provide the information of the Target Group Member at a first glance. The elements located directly at the node Member Overview can be defined by the data type TargetGroupMemberOverviewElements. These elements can include TargetGroupUUID, TargetGroupID, TargetGroupDescription, MemberNumberValue, TargetGroupStatus, CustomerUUID, CustomerInternalID, CustomerFormattedName, ContactPersonUUID, ContactPersonInternalID, ContactPersonFormattedName, and ContactAllowedCode. TargetGroupUUID is a Universally Unique Identifier of a Target Group, and can be defined by a UUID data type. TargetGroupID is an identifier of a Target Group, and can be defined by a TargetGroupID data type. TargetGroupDescription is an optional description of a Target Group, and can be defined by a MEDIUM_Description data type, qualified by TargetGroup. MemberNumberValue can be defined by a NumberValue data type. TargetGroupStatus can be defined by a TargetGroupStatus business object data type. TargetGroupStatus/LifeCycleStatusCode is a Life Cycle Status of a Target Group, and can be defined by a TargetGroupLifeCycleStatusCode data type. In some implementations, no Marketing Activities may be performed for Target Groups with an ActivationStatusCode of “Blocked” or “Obsolete”.

In some implementations, an ActivationStatusCode of “Active” may be the default status for new Target Groups. In some implementations, an ActivationStatusCode of “Obsolete” may be a condition for deleting a Target Group. CustomerUUID is a universally unique identifier of a Customer to which a Target Group Member belongs. CustomerUUID can be defined by a UUID data type. The Customer, for example, can be a Prospect, a Customer (Organisation), or a Customer (Person). CustomerInternalID is an internal ID of a Customer to which a Target Group member belongs. CustomerInternalID can be defined by a BusinessPartnerInternalID data type. The Customer, for example, can be a Prospect, a Customer (Organisation), or a Customer (Person). CustomerFormattedName is an optional Formatted Name of a Customer to which a Target Group Member belongs. CustomerFormattedName can be defined by a LANGUAGEINDEPENDENT_LONG_Name data type, qualified by Formatted. The Customer, for example, can be a Prospect, a Customer (Organisation), or a Customer (Person). ContactPersonUUID is an optional universally unique identifier of a Contact Person which represents a Target Group Member. ContactPersonUUID can be defined by a UUID data type. The Contact Person, for example, can be a Contact Person of a Customer assigned to a member. In some implementations, a ContactPersonUUID attribute may be populated if a Customer is assigned to a member. ContactPersonInternalID is an optional identifier of a Contact Person which represents a Target Group Member. ContactPersonInternalID can be defined by a BusinessPartnerInternalID data type.

The Contact Person, for example, can be a Contact Person of a Customer assigned to the member. In some implementations, a ContactPersonInternalID attribute may be populated if a Customer is assigned to a member. ContactPersonFormattedName is an optional Formatted Name of a Contact Person which represents a Target Group Member. ContactPersonFormattedName can be defined by a LANGUAGEINDEPENDENT_LONG_Name data type, qualified by PersonFormatted. The Contact Person, for example, can be a Contact Person of the Customer assigned to the member. In some implementations, a ContactPersonFormattedName attribute may be populated if a Customer is assigned to a member. ContactAllowedCode is an optional contact allowed code of a Target Group Member, and can be defined by a ContactAllowedCode data type. The Contact Allowed Code, for example, can be the contact allowed code of a customer associated with a target group member. A specialization association for navigation to the node Member can exist: To Parent, with a target cardinality of 1. A specialization association for navigation to the node Target Group can exist: To Root, with a target cardinality of 1.

A Query By Elements query can exist for a Member Overview. Query By Elements can provide a list of all Member Overview-node instances found for a Target Group ID, a Target Group Description, a Target Group Member Group Code, a Target Group Member Contact Allowed Code, a Target Group Member Contact Person Formatted Name or ID, and/or a Target Group Member Customer Formatted Name or ID. The query elements can be defined by the data type TargetGroupMemberOverviewElementsQueryElements, and can include TargetGroupUUID, TargetGroupID, TargetGroupDescription, TargetGroupStatus, CustomerUUID, CustomerInternalID, CustomerName, CustomerAdditionalName, CustomerCommonSortingFormattedName, ContactPersonUUID, ContactPersonInternalID, ContactPersonFamilyName, ContactPersonGivenName, ContactPersonCommonSortingFormattedName, ContactAllowedCode, and SearchText elements. TargetGroupUUID can be defined by a UUID data type. TargetGroupID can be defined by a TargetGroupID data type. TargetGroupDescription can be defined by a MEDIUM_Description data type, qualified by TargetGroup. TargetGroupStatus can be defined by a TargetGroupStatus business object data type. TargetGroupStatus/LifeCycleStatusCode is a Life Cycle Status of a Target Group, and can be defined by a TargetGroupLifeCycleStatusCode data type. In some implementations, no Marketing Activities may be performed for Target Groups with an ActivationStatusCode of “Blocked” or “Obsolete”. In some implementations, an ActivationStatusCode of “Active” can be a default status for new Target Groups. In some implementations, an ActivationStatusCode of “Obsolete” can be a condition for deleting a Target Group. CustomerUUID can be defined by a UUID data type. CustomerInternalID can be defined by a BusinessPartnerInternalID data type. CustomerName is a name of a customer associated with a target group member. CustomerName can be defined by a LANGUAGEINDEPENDENT_MEDIUM_Name data type, qualified by Customer. CustomerAdditionalName is an additional name of a customer associated with a target group member.

CustomerAdditionalName can be defined by a LANGUAGEINDEPENDENT_MEDIUM_Name data type, qualified by CustomerAdditional. CustomerCommonSortingFormattedName is a common sorting formatted name of a customer associated with a target group member. CustomerCommonSortingFormattedName can be defined by a LANGUAGEINDEPENDENT_LONG_Name data type, qualified by Formatted. ContactPersonUUID can be defined by a UUID data type. ContactPersonInternalID is an internal ID of a contact person referenced by a target group member, and can be defined by a BusinessPartnerInternalID data type. ContactPersonFamilyName is a family name of a contact person referenced by a target group member. ContactPersonFamilyName can be defined by a LANGUAGEINDEPENDENT_MEDIUM_Name data type, qualified by Family. ContactPersonGivenName is a given name of a contact person referenced by a target group member. ContactPersonGivenName can be defined by a LANGUAGEINDEPENDENT_MEDIUM_Name data type, qualified by Given. ContactPersonCommonSortingFormattedName is a common sorting formatted name of a contact person referenced by a target group member. ContactPersonCommonSortingFormattedName can be defined by a LANGUAGEINDEPENDENT_LONG_Name data type, qualified by Formatted. ContactAllowedCode can be defined by a ContactAllowedCode data type. SearchText can be defined by a SearchText data type.

Overview provides a general view on a Target Group, and can provide the information of the Target Group at a first glance. The elements located directly at the node Overview can be defined by the data type TargetGroupOverviewElements. These elements can include TargetGroupUUID, TargetGroupID, CreationBusinessPartnerUUID, CreationBusinessPartnerFormattedName, CreationDateTime, LastChangeBusinessPartnerUUID, LastChangeBusinessPartnerFormattedName, LastChangeDateTime, TargetGroupDescription, MemberNumberValue, and TargetGroupStatus. TargetGroupUUID is a universally unique identifier of a Target Group, and can be defined by a UUID data type. TargetGroupID is a human readable unique identifier of a Target Group, and can be defined by a TargetGroupID data type. CreationBusinessPartnerUUID is an optional Universally Unique Identifier of a Business Partner who created a Target Group. CreationBusinessPartnerUUID can be defined by a UUID data type. CreationBusinessPartnerFormattedName is an optional Formatted Name of a Business Partner who created a Target Group.

CreationBusinessPartnerFormattedName can be defined by a LANGUAGEINDEPENDENT_LONG_Name data type, qualified by BusinessPartnerFormatted. CreationDateTime is a date and time when a Target Group was created. CreationDateTime can be defined by a GLOBAL_DateTime data type, qualified by Creation. LastChangeBusinessPartnerUUID is an optional universally unique identifier of a Business Partner who last changed a Target Group. LastChangeBusinessPartnerUUID can be defined by a UUID data type. LastChangeBusinessPartnerFormattedName is an optional Formatted Name of a Business Partner who last changed a Target Group. LastChangeBusinessPartnerFormattedName can be defined by a LANGUAGEINDEPENDENT_LONG_Name data type, qualified by BusinessPartnerFormatted. LastChangeDateTime is an optional date and time when a Target Group was last changed. LastChangeDateTime can be defined by a GLOBAL_DateTime, qualified by LastChange. TargetGroupDescription is an optional natural language description of a Target Group. TargetGroupDescription can be defined by a MEDIUM_Description data type, qualified by TargetGroup. MemberNumberValue is a number of Members which currently belong to a Target Group. MemberNumberValue can be defined by a NumberValue data type, qualified by Member. TargetGroupStatus is a status of a Target Group, and can be defined by a TargetGroupStatus business object data type. TargetGroupStatus/LifeCycleStatusCode is a Life Cycle Status of a Target Group, and can be defined by a TargetGroupLifeCycleStatusCode data type. In some implementations, no Marketing Activities may be performed for Target Groups with an ActivationStatusCode of “Blocked” or “Obsolete”. In some implementations, an ActivationStatusCode of “Active” may be the default status for new Target Groups. In some implementations, an ActivationStatusCode of “Obsolete” may be a condition for deleting a Target Group. The following specialization associations for navigation to the node Target Group can exist: To Parent, with a target cardinality of 1, and To Root, with a target cardinality of 1.

A Query By Elements query can exist for an Overview. Query By Elements provides a list of all Overview-node instances found for an ID, a description, a number of members, a creation identity or a last changed identity, and/or a LifeCycleStatus. The query elements can be defined by the data type TargetGroupOverviewElementsQueryElements, and can include TargetGroupUUID, TargetGroupID, SystemAdministrativeData, TargetGroupDescription, MemberNumberValue, TargetGroupStatus, and SearchText elements. TargetGroupUUID is a universally unique identifier of a Target Group, and can be defined by a UUID data type. TargetGroupID is a human readable unique Identifier of a Target Group, and can be defined by a TargetGroupID data type. SystemAdministrativeData is System Administrative Data (e.g., date and time, identity of creation and change of a Target Group). SystemAdministrativeData can be defined by a SystemAdministrativeData data type. TargetGroupDescription is a natural language description of a Target Group. TargetGroupDescription can be defined by a MEDIUM_Description data type, qualified by TargetGroup. MemberNumberValue is a number of Members which currently belong to a Target Group.

MemberNumberValue can be defined by a NumberValue data type, qualified by Member. TargetGroupStatus is a status of a Target Group, and can be defined by a TargetGroupStatus data type. TargetGroupStatus/LifeCycleStatusCode is a Life Cycle Status of a Target Group, and can be defined by a TargetGroupLifeCycleStatusCode data type. In some implementations, no Marketing Activities may be performed for Target Groups with an ActivationStatusCode of “Blocked” or “Obsolete”. In some implementations, an ActivationStatusCode of “Active” can be a default status for new Target Groups. In some implementations, an ActivationStatusCode of “Obsolete” can be a condition for deleting a Target Group. SearchText is free text containing one or several words (search terms) to search for Target Groups. SearchText can be defined by a SearchText data type. In some implementations, for every query that includes SearchText as a query parameter, an application-specific subset of other query parameters is defined. In general, a query result may be calculated as follows: Search terms can be assigned to a subset of query parameters in such a way that every search term is used exactly once in an assignment. For example, several search terms may be assigned to the same query parameter; for each of these assignments a query result can be calculated. The total result, for example, can be the union of the results calculated per assignment.

An inbound service ManageTargetGroupIn can be associated with a Campaign Management process component and with a Customer Relationship Management deployment unit, can be a stateless web service, can be used to manage information about target groups, can be associated with a Maintain as Bundle operation and a Check Maintain as Bundle operation, and can be used to migrate target group data from a source system or file.

The web service interface Manage Target Group In can be used an interface to replicate target groups from a source system or file to a target system. The web service interface Manage Target Group In can provide the operations Maintain As Bundle and Check Maintain As Bundle.

Below is an example of a web service request.

< n0:TargetGroupBundleMaintainRequest_sync xmlns:n0=″exampleNamespace”
<TargetGroup actionCode=″1″ memberListCompleteTransmissionIndicator=″true″>
<ObjectNodeSenderTechnicalID>Token 14</ObjectNodeSenderTechnicalID>
<ChangeStateID>Token 15</ChangeStateID>
<UUID>12345678-90AB-CDEF-0123-456789ABCDEF</UUID>
<ID>121</ID>
<Description>A description</Description>
<LifeCycleStatusCode>1</LifeCycleStatusCode>
<Note actionCode=″1″>
<ObjectNodeSenderTechnicalID>Token 24</ObjectNodeSenderTechnicalID>
<ContentText>A note</ContentText>
</Note>
<Member actionCode=″1″>
<ObjectNodeSenderTechnicalID>Token 27</ObjectNodeSenderTechnicalID>
<UUID>12345678-90AB-CDEF-0123-456789ABCDEF</UUID>
<CustomerUUID>12345678-90AB-CDEF-0123-456789ABCDEF</CustomerUUID>
<CustomerInternalID>Token 32</CustomerInternalID>
<ContactPersonUUID>12345678-90AB-CDEF-0123-456789ABCDEF
</ContactPersonUUID>
<ContactPersonInternalID>Token 35</ContactPersonInternalID>
</Member>
</TargetGroup>
</n0:TargetGroupBundleMaintainRequest_sync>

Regarding the existence of referenced business data, some business data may only be referenced by target group members and may not be created by the service operations. For example, such data can exist in the system at the time the web service is called.

Action codes can represent an instruction to a recipient of a web service request to process transmitted message node elements. An action code of “01” can represent a creation. The system can return an error message if a node element to create already exists. An action code of “02” can represent an update. The system can return an error message if the node element to update does not exist. An action code of “03” can represent a deletion. The system can return an error message if the node element to delete does not exist. An action code of “04” can represent a save. A save can result in the creation and/or changing of node element data. An action code of “05” can represent a removal. In response to a remove request, the system can delete a node element. In some implementations, the system does not send an error message if the node element to remove does not exist (e.g., in contrast to the delete action code). An action code of “06” can represent “No Action”. In response to a “No Action” action code, the system does not change a specified node element. In some implementations, a default action code can exist. In some implementations, the default action code is “04” save.

Request node elements with cardinality >1 can contain an object node sender technical identifier to relate response message elements and log items to corresponding node elements in the request message. The object node sender technical identifiers can be provided as “ObjectNodeSenderTechnicalID” in request message types and referred to as “ReferenceObjectNodeSenderTechnicalID” in corresponding response message types.

If the object node sender technical ID is initial, the object node sender technical ID of the parent node element in the request can be returned as the reference object node sender technical ID. If the object node sender technical IDs of all parent node elements are initial, the reference object node sender technical ID can be returned as initial as well. In some implementations, the values specified in the “ObjectNodeSenderTechnicalID” can be transient values that establish the correspondence between elements for a single call. In some implementations, the web service consumer may not be required to specify them or to use the same values for different calls. In some implementations, the service provider may not interpret these values at all, but can return them to the web service consumer instead in the “ReferenceObjectNodeSenderTechnicalID” elements.

Using a change state identifier (e.g., element name “ChangeStateID”), external applications can enforce that a modifying operation is not executed because the state of the business document has changed since the external application read its data. In some implementations, the change state ID may not be an interpretable string that is provided by query and read operations and utilized by all modifying operations. If the change state identifier is provided when calling a modifying operation, the system does not perform the operation if the state of the business document instance has changed since the change state ID was computed. In some implementations, if the change state ID is not provided by the service consumer, then the system can perform the service operation without checking the state of the business document. In some implementations, the service consumer (external application) is responsible for preventing accidental changes to business documents.

The processing of node elements with cardinality >1 can be controlled using one or more List Complete Transmission Indicators (LCTI). A LCTI can indicate whether a list of node elements is transmitted completely. The LCTI of a node element with cardinality >1 can be modeled as an attribute of its parent node element (attribute name: <name of child element>ListCompleteTransmissionIndicator).

False and true values can exist and be used. A false value (default value) can indicate that the list of node elements is not transmitted completely and hence all node elements that are not transmitted remain unchanged. If transmitted node elements in the list can be identified uniquely, the system can process the node elements according to the action code. If transmitted node elements in the list cannot be identified uniquely, the system can append the node element to the corresponding list of node elements in the target business document. For a true value, the list of elements can be transmitted completely and hence all node elements that are not transmitted are removed. If no node element is transmitted, the complete list can be removed.

For example, the Target Group node can have a memberListCompleteTransmissionIndicator. If a target group has already 100 members in the system and the consumer wants to add two additional ones, then the consumer can pass these two new members with ActionCode 01 in the message payload and can set the member LCTI to false. Then the two members can be added and the already existing 100 members can be kept. If the consumer wants to remove all members except those two just added, then the consumer can again pass these two members but can set the member LCTI to true. Then all members can be removed which are not contained in the message payload. Optional elements in request messages that are not transmitted within a service request may not be changed in corresponding business objects.

In the following example, Description is set to initial:

<TargetGroup actionCode=“02”>
<ID>431</ID>
<Description></Description>
<LifeCycleStatusCode>3</LifeCycleStatusCode>
</TargetGroup>

In the following example, Description is not changed:

<TargetGroup actionCode=“02”>
<ID>431</ID>
<LifeCycleStatusCode>3</LifeCycleStatusCode>
</TargetGroup>

Regarding obsolete target groups, generally target groups with status “obsolete” cannot be changed. In some implementations, they can only be deleted or set to a status which allows further changes such as, “active” or “blocked”. This restriction can apply to the maintenance of target groups using this web service as well. In some implementations, it is not possible to set a target group to “obsolete” and to submit further changes, for example, maintenance of root or member data, in one step. First, the maintenance operations can be submitted, and in a second service call the target group can be set to “obsolete”. In some implementations, it is not possible to set back a target group from “obsolete” and to submit further changes, for example, maintenance of root or member data, in one step. First, the target group status can be set to a value different than “obsolete”, and in a second service call the maintenance operations can be submitted.

In the following example scenario and associated steps, the consumer wants to create a target group and a campaign using this target group. First, the target group can be created using this service. The target group ID delivered in the response can then be used to create a campaign using the service “Manage Campaign In”.

Step 1 can involve creating a target group with two members, using the following request:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“01”>
<Description>Description of TG</Description>
<Member actionCode=“01”>
<CustomerInternalID>MC9785</CustomerInternalID>
<ContactPersonInternalID>MCP9785</ContactPersonInternalID>
</Member>
<Member actionCode=“01”>
<CustomerInternalID>MC9786</CustomerInternalID>
<ContactPersonInternalID>MCP9786</ContactPersonInternalID>
</Member>
</TargetGroup>
</n0:TargetGroupBundleMaintainRequest_sync>

The request can result in the following response:

<nm:TargetGroupBundleMaintainConfirmation_sync
xmlns:nm=“exampleNamespace”>
<TargetGroup>
<ReferenceObjectNodeSenderTechnicalID />
<ChangeStateID>20120627145254.4922380</ChangeStateID>
<UUID>00163e02-8b2e-led1-b08c-f7f96602c11b</UUID>
<ID>443</ID>
</TargetGroup>
<Log />
<nm:TargetGroupBundleMaintainConfirmation_sync>

Step 2 can involve creating a campaign using the new target group, using the following request:

<n0:CampaignBundleMaintainRequest_sync
xmlns:n0=“exampleNamespace”>
<BasicMessageHeader>
</BasicMessageHeader>
<Campaign>
<Description>A2X Manage Bundle In 2012/06/13</Description>
<PlannedStartDate>2012-06-13</PlannedStartDate>
<PlannedEndDate>2012-07-27</PlannedEndDate>
<LifeCycleStatusCode>1</LifeCycleStatusCode>
<ExecutionStep>
<TargetGroupID>443</TargetGroupID>
<ExecutionTypeCode>1</ExecutionTypeCode>
</ExecutionStep>
</Campaign>
</n0:CampaignBundleMaintainRequest_sync>

The request can result in the following response:

<nm:CampaignBundleMaintainConfirmation_sync
xmlns:nm=“exampleNamespace”>
<Campaign>
<ChangeStateID>20120627074556.5579770</ChangeStateID>
<ReferenceObjectNodeSenderTechnicalID />
<UUID>00163e02-8b34-1ee1-afed-037b699d9b3d </UUID>
<ID>711</ID>
</Campaign>
<Log />
</nm:CampaignBundleMaintainConfirmation_sync>

The following paragraphs describe the Maintain As Bundle operation of the Manage Target Group In interface that can have a name of MaintainBundle, can be synchronous, and can be used to create, update or delete one or more target groups using imported structured data. In some implementations, the web service request and response message types for the CheckMaintainBundle operation can be the same as those of the Maintain Bundle operation.

The request message of the operation MaintainBundle can include a BasicMessageHeader node element as well as a target group node element that includes data to be maintained. The node can occur multiple times in the request message, which means that multiple target groups can be maintained through a single web service request.

The target group node element can include general target group information, such as attributes actionCode and memberListCompleteTransmissionIndicator, as well as elements: ObjectNodeSenderTechnicalID, ChangeStateID, UUID, ID, Description, LifeCycleStatusCode (e.g., codes 1=active, 2=blocked, 3=obsolete), and/or other elements and data. Some or all of the data for the target group node can be related to general data on a target group user interface. The UUID and ID each can be a unique identifier of a target group used to identify a target group for modification. Updating or deleting target groups can be done either by identifying the UUID or the ID element. In some implementations, only target groups with status obsolete can be deleted.

In an example, for creating a target group, the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“01”>
<Description>Description of TG</Description>
<LifeCycleStatusCode>1</LifeCycleStatusCode>
</TargetGroup>
</n0:TargetGroupBundleMaintainRequest_sync>

In another example, for updating a target group, the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“02”>
<ID>431</ID>
<Description>updated: Description</Description>
<LifeCycleStatusCode>3</LifeCycleStatusCode>
</TargetGroup>
</n0:TargetGroupBundleMaintainRequest_sync>

In some implementations, the node element note can mainly contain the text of a note for a target group. Elements can include an actionCode attribute and elements ObjectNodeSenderTechnicalID and ContentText. In some implementations, the Target Group business object supports only one note instance. If an additional note is transmitted by the consumer for creation, then the system can update the already existing note with the provided text. Using the ActionCode, it is possible to delete the note instance. In some implementations, empty notes cannot be created. If empty note content is provided, then the system can remove the whole note instance (ActionCodes 02 and 04) or can ignore the creation of it (ActionCode 01).

In an example of creating a note for an already existing target group, the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“06”>
<ID>431</ID>
<Note actionCode=“01”>
<ContentText>This is a note.</ContentText>
</Note>
</TargetGroup>
</n0:TargetGroupBundleMaintainRequest_sync>

In an example of deleting a note for an already existing target group, the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“06”>
<ID>434</ID>
<Note actionCode=“03”>
</Note>
</TargetGroup>
</n0:TargetGroupBundleMaintainRequest_sync>

In some implementations, using this node, element members can be added to or removed from a target group. The node can include an action Code attribute and the following elements: an Object Node Sender Technical ID, a UUID to identify a member for deletion, a Customer UUID to identify the customer to be added, a Customer Internal ID to identify the customer to be added, a Contact Person UUID to identify the contact person to be added, and a Contact Person Internal ID to identify the contact person to be added.

In some implementations, target group members cannot be updated. If a consumer wants to update a member, for example, replace the contact person, the member instance can be deleted and a new one can be created. The consumer can receive a corresponding error in the log section of the response if the consumer transfers members with Action Code 02. In some implementations, to add a member to a target group, a customer can be specified. It can be possible to pass either the Customer UUID or the Customer ID. In addition a contact person can be specified. Here also passing the UUID or the ID is possible. In some implementations, when members are added, an implicit check on duplicates is done. Warnings can be put into the log section of the response if a customer—contact person—combination can be added which is already available in the specified target group. In some implementations, to delete target group members, the members can be identified by the member UUID. The member UUIDs can be obtained using the Target Group Query Service.

In an example of adding members to a target group, the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“04”>
<ID>431</ID>
<Member actionCode=“01”>
<CustomerInternalID>MC9785</CustomerInternalID>
<ContactPersonInternalID>MCP9785</ContactPersonInternalID>
</Member>
<Member actionCode=“01”>
<CustomerInternalID>MC9786</CustomerInternalID>
<ContactPersonInternalID>MCP9786</ContactPersonInternalID>
</Member>
</TargetGroup>
</n0:TargetGroupBundleMaintainRequest_sync>

In an example of deleting all members from a target group and adding new members (using LCTI), the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“04”
memberListCompleteTransmissionIndicator=“true”>
<ID>431</ID>
<Member actionCode=“01”>
<CustomerInternalID>MC9785</CustomerInternalID>
<ContactPersonInternalID>MCP9785</ContactPersonInternalID>
</Member>
<Member actionCode=“01”>
<CustomerInternalID>MC9786</CustomerInternalID>
<ContactPersonInternalID>MCP9786</ContactPersonInternalID>
</Member>
</TargetGroup>
</n0:TargetGroupBundleMaintainRequest_sync>

In an example of deleting members from a target group, the request can be:

<n0:TargetGroupBundleMaintainRequest_sync
xmlns:n0=“exampleNamespace”>
<BasicMessageHeader>
<ID>00300571D06B1DED9EE4723F124207BC</ID>
</BasicMessageHeader>
<TargetGroup actionCode=“06”>
<ID>431</ID>
<Member actionCode=“03”>
<UUID>00163E02-8B2E-1EE1-B084-C9B56C75CEFC</UUID>
</Member>
<Member actionCode=“03”>
<UUID>00163E02-8B2E-1EE1-B084-C9B56C75EEFC</UUID>
</Member>
</TargetGroup>
</n0:TargetGroupBundleMaintainRequest_sync>

The response can include two parts: 1) information about IDs and UUIDs of the created, changed or deleted target groups, and 2) Log items containing system messages including errors, warnings, and information messages raised by the system during processing of the service request. The severity code can specify whether the message is of type error (3), warning (2) or information (1).

In an example of creating a target group, the response can be:

<nm:TargetGroupBundleMaintainConfirmation_sync
xmlns:nm=“exampleNamespace”>
<TargetGroup>
<ReferenceObjectNodeSenderTechnicalID>Token 14
</ReferenceObjectNodeSenderTechnicalI
<ChangeStateID>20120627084217.8722850</ChangeStateID>
<UUID>00163e02-8b2e-1ee1-b086-7fd3dd4012df</UUID>
<ID>442</ID>
</TargetGroup>
<Log />
</nm:TargetGroupBundleMaintainConfirmation_sync>

In an example of adding already existing members to a target group, the response can be:

<nm:TargetGroupBundleMaintainConfirmation_sync
xmlns:nm=“exampleNamespace”>
<Log>
<MaximumLogItemSeverityCode>2</MaximumLogItemSeverityCode>
<Item>
<TypeID>112(/CL_APCRM_TG_OB/)</TypeID>
<CategoryCode>INC.BOI</CategoryCode>
<SeverityCode>2</SeverityCode>
<Note>Adding 2 members not possible; they already exist in target group
</Note>
</Item>
</Log>
</nm:TargetGroupBundleMaintainConfirmation_sync>

In an example of deleting a non obsolete target group, the response can be:

<nm:TargetGroupBundleMaintainConfirmation_sync
xmlns:nm=“exampleNamespace”>
− <Log>
<MaximumLogItemSeverityCode>3</MaximumLogItemSeverityCode>
<Item>
<TypeID>108(/AP_ESI_COMMON/)</TypeID>
<CategoryCode>INC.BOI</CategoryCode>
<SeverityCode>3</SeverityCode>
<ReferenceObjectNodeSenderTechnicalID>Token 14
</ReferenceObjectNodeSenderTechnicalI
<Note>Deleting data not possible; deletion disabled</Note>
</Item>
</Log>
</nm:TargetGroupBundleMaintainConfirmation_sync>

Another operation is Operation Check Maintain As Bundle for managing a target group and having a name CheckMaintainBundle and which may be synchronous, and can be used to check whether one or more Target Groups can be maintained using imported structured data. The web service request and response message types for the CheckMaintainBundle operation can be the same as, or different from, those of the Maintain Bundle operation. The explanations given above can therefore also be applied to the CheckMaintainBundle operation.

FIG. 33 illustrates one example logical configuration of a target group bundle maintain request sync message 33000. Specifically, this figure illustrates one example logical configuration of a target group bundle maintain request sync message 33000. Specifically, this figure depicts the arrangement and hierarchy of various components such as one or more levels of packages, entities, and data types, shown here as 33000 through 33008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the target group bundle maintain request sync message 33000 includes, among other things, the note entity 33006. Accordingly, heterogeneous applications may communicate using this consistent message configured as such.

The message type Target Group Bundle Maintain Request_sync is derived from the business object Target Group as a leading object together with its operation signature. The message type Target Group Bundle Maintain Request_sync is a request to maintain one or more target groups. The structure of the message type Target Group Bundle Maintain Request_sync is determined by the message data type TargetGroupMaintainRequestBundleMessagesync. The message data type TargetGroupMaintainRequestBundleMessagesync includes the packages: BasicMessageHeader and TargetGroup. BasicMessageHeader is typed by BusinessDocumentBasicMessageHeader.

TargetGroup includes the following attributes: actionCode and memberListCompleteTransmissionIndicator. The actionCode attribute may have a multiplicity of 0 . . . 1 and may be based on datatype BGDT:ActionCode. The memberListCompleteTransmissionIndicator may have a multiplicity of 0 . . . 1 and may be based on datatype CDT:Indicator. TargetGroup includes the following non-node elements: ObjectNodeSenderTechnicalID, ChangeStateID, UUID, ID, Description, and LifeCycleStatusCode. ObjectNodeSenderTechnicalID may have a multiplicity of 0 . . . 1 and may be based on datatype BGDT:ObjectNodePartyTechnicalID. ChangeStateID may have a multiplicity of 0 . . . 1 and may be based on datatype BGDT:ChangeStateID. UUID may have a multiplicity of 0 . . . 1 and may be based on datatype BGDT:UUID. ID may have a multiplicity of 0 . . . 1 and may be based on datatype BGDT:TargetGroupID. Description may have a multiplicity of 0 . . . 1 and may be based on datatype BGDT:LANGUAGEINDEPENDENT_MEDIUM_Description. LifeCycleStatusCode may have a multiplicity of 0 . . . 1 and may be based on datatype BGDT:TargetGroupLifeCycleStatusCode.

TargetGroup includes the following node elements: Note, in a 1:C cardinality relationship; and Member, in a 1:CN cardinality relationship. Note includes the actionCode attribute, which may have a multiplicity of 0 . . . 1 and may be based on datatype BGDT:ActionCode. TargetGroup includes the following non-node elements: ObjectNodeSenderTechnicalID and ContentText. ObjectNodeSenderTechnicalID may have a multiplicity of 0 . . . 1 and may be based on datatype BGDT:ObjectNodePartyTechnicalID. ContentText may have a multiplicity of 0 . . . 1 and may be based on datatype CDT:LANGUAGEINDEPENDENT_Text.

Member includes the actionCode attribute, which may have a multiplicity of 0 . . . 1 and may be based on datatype BGDT:ActionCode. Member includes the following non-node elements: ObjectNodeSenderTechnicalID, UUID, CustomerUUID, CustomerInternalID, ContactPersonUUID, and ContactPersonInternalID. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. CustomerUUID may have a multiplicity of 0 . . . 1 and may be based on datatype BGDT:UUID. CustomerInternalID may have a multiplicity of 0 . . . 1 and may be based on datatype BGDT:BusinessPartnerInternalID. ContactPersonUUID may have a multiplicity of 0 . . . 1 and may be based on datatype BGDT:UUID. ContactPersonInternalID may have a multiplicity of 0 . . . 1 and may be based on datatype BGDT:BusinessPartnerInternalID.

FIGS. 34-1 through 34-8 show an example configuration of an Element Structure that includes a Target Group Bundle Maintain Request_sync 340000 package. Specifically, these figures depict the arrangement and hierarchy of various components such as one or more levels of packages, entities, and datatypes, shown here as 340000 through 340262. As described above, packages may be used to represent hierarchy levels. Entities are discrete business elements that are used during a business transaction. Data types are used to type object entities and interfaces with a structure. For example, the Target Group Bundle Maintain Request_sync 340000 includes, among other things, a Target Group Bundle Maintain Request_sync 340002. Accordingly, heterogeneous applications may communicate using this consistent message configured as such.

A number of implementations have been described. Nevertheless, it will be understood that various modifications may be made without departing from the spirit and scope of the disclosure. Accordingly, other implementations are within the scope of the following claims.

What is claimed is:

1. A computer readable medium including program code for providing a message-based interface for exchanging information about target groups, the medium comprising:
program code for receiving via a message-based interface exposing at least one service as defined in a service registry and from a heterogeneous application executing in an environment of computer systems providing message-based services, a first message for requesting maintenance of one or more target groups, including a list of business partners that include customers, prospects and/or contact persons, categorized according to specific criteria, including geographical locations and/or common interests, the first message including a message package hierarchically organized as:
a target group bundle maintain request sync message entity; and
a target group package including at least one target group entity, wherein each target group entity includes at least one of an object node sender technical identifier (ID) and a change state ID; and
program code for sending a second message to the heterogeneous application responsive to the first message.

2. The computer readable medium of claim 1, wherein each target group entity further includes at least one of the following: a note entity and a member entity.

3. The computer readable medium of claim 1, wherein each target group entity further includes at least one of the following: a universally unique identifier (UUID), an ID, a description, and a life cycle status code.

4. The computer readable medium of claim 1, wherein the note entity includes at least one of the following: an object node sender technical ID and content text.

5. The computer readable medium of claim 1, wherein the member entity includes at least one of the following: an object node sender technical ID, a UUID, a customer UUID, a customer internal ID, a contact person UUID, and a contact person internal ID.

6. A distributed system operating in a landscape of computer systems providing message-based services defined in a service registry, the system comprising:
a graphical user interface comprising computer readable instructions, embedded on tangible media, for requesting maintenance of one or more target groups, including a list of business partners that include customers, prospects and/or contact persons, categorized according to specific criteria, including geographical locations and/or common interests, the instructions using a request;
a first memory storing a user interface controller for processing the request and involving a message including a message package hierarchically organized as:
a target group bundle maintain request sync message entity; and
a target group package including at least one target group entity, wherein each target group entity includes at least one of an object node sender technical identifier (ID) and a change state ID; and
a second memory, remote from the graphical user interface, storing a plurality of service interfaces, wherein one of the service interfaces is operable to process the message via the service interface.

7. The distributed system of claim 6, wherein the first memory is remote from the graphical user interface.

8. The distributed system of claim 6, wherein the first memory is remote from the second memory.
